(19) United States
(12) Patent Application Publication
(10) Pub. No.: US 2011/0166962 A1
(43) Pub. Date: Jul. 7, 2011

(54) ON-LINE TRADING SYSTEM

(76) Inventors: Juha Koponen, Helsinki (FI); Jussi Koskinen, Espoo (FI)

(21) Appl. No.: 12/737,601

(22) PCT Filed: Aug. 7, 2008
(86) PCT No.: PCT/EP2008/060406

§ 371 Date: Mar. 21, 2011

(51) Int. Cl. G06Q 30/00

(52) U.S. Cl. 705/27.1

(57) ABSTRACT

A method of constructing and maintaining a group hierarchy for use in an online trading system accessible to a multiplicity of end users, where nodes of the hierarchy define respective item and/or service groups with progressively increasing levels of detail. Items and/or services offered for trade on the system are directly associated with at least one group. The method includes receiving end user requests to create respective new groups, each request including one or more parameter fields for describing items or services belonging to the group and one or more locations within the existing group hierarchy, and modifying the existing hierarchy to accommodate the new groups.

### TECHNICAL FIELD

The present invention relates to on-line trading systems and in particular, though not necessarily, to on-line trading systems that allow the general public to either sell or exchange personal items and services.

### BACKGROUND

A number of websites have appeared in recent years to facilitate the exchange or bartering of items and services between members of the public. An example is the Swaptree™ site available at www.swaptree.com. In a two-way barter, two people directly swap their items or services. The problem of course with two-way barter is that, particularly for unusual items, it may be difficult for a first party to link up with another party who has exactly what the first party is looking for. The probability of finding a barter partner grows dramatically in large user base when n-way barter is allowed. In an n-way barter a group of people exchange their “Have's” and “Want's”. Consider for example the case of three users, C1, C2 and C3, who each have their own Have's and Want's (written here in brackets (Have, Want)): C1(A,B), C2(B,C) and C3 (C,A). In this case, the exchange can be coordinated to ensure that each user gets what he/she wants.

On-line barter systems are considered in the following publications; U.S. Pat. No. 6,847,938, KR20010025282, WO2006034221, WO0124091, WO2004027660, US2003088497, JP2003076881, JP2002318936, JP2002269385, WO0139081, WO2008057255, WO2008057276, WO2008057277, US2007244769, US2007244770, US2007244772, US2007244793, US20070244801, US20070255624, WO2007121298, and WO2007121305.

Barter sites share many characteristics with on-line auction and sales sites such as Ebay™ and Wigix™ (www.wigix.com). However, the former are necessarily more complex in that a search of the listings must identify both have's and want's, and not only have's as in the case of the auction sites. Moreover, a search on a barter site should identify all possible n-way barters. For this reason, especially in the case of a large user base, it is desirable to automate as much as possible the searching process in a barter system, rather than leaving it to the user to “manually” browse through categories and items. Automated searching relies heavily upon the accurate and detailed categorisation of offered items and services and may be carried out “on-demand”, i.e. in response to a user entering a Have and a Want into the system, or by way of periodic “clearing” in which user requests are queued and subsequently cleared in a single pass through the system.

In order to simplify the process of listing and identifying items (or services) for exchange, a barter system may make use of statically defined categories. These may be organised in a hierarchical tree-like structure. For example, “LCD televisions” may be a sub-category under the sub-category “television” and the top level category “home electronics”. Users, when listing their barter requests in the system, connect each Have and Want with a specific product category (typically at the lowest level in the tree). In addition, users may add a textual description/keywords for the Have's and Want's (and optionally a photograph of the Have). An automated search will typically employ a keyword search within the specified category.

Statically defined categories are necessarily coarse grained. For example, whilst high level genre categories for books may be defined, e.g. history, science fiction, etc, finer definition is not possible, e.g. “Finnish winter war”, due to the intensive nature of the categorisation process. In any case, there is always a limit to the degree of classification that a system provider is willing to create, e.g. if a “Finnish winter war” category is defined, a sub-category for “Moscow Peace Treaty” will not.

A further drawback of the current category-based systems is that certain categories may be poorly or inadequately defined. Users must work within the confines of such categories. Yet another drawback is that, on any given site, categories are specified in a single language. Unless a site is to be restricted to a particular geographic region, e.g. Finland, the site will typically operate in English. Of course, this excludes a massive number of potential users.

Whilst these disadvantages are particularly acute in the case of on-line barter systems, they are also present in other on-line trading systems including on-line auction systems.

### SUMMARY

It is an object of the present invention to overcome or at least mitigate the above noted disadvantages of conventional on-line trading systems. These and other disadvantages may be overcome by allowing users themselves to create and amend product and service categories, and to position these at appropriate levels within a category hierarchy.

According to a first aspect of the present invention there is provided a method of constructing and maintaining a group hierarchy for use in an online trading system accessible to a multiplicity of end users, where nodes of the hierarchy define respective item and/or service groups with progressively increasing levels of detail, items and/or services offered for trade on the system being directly associated with at least one group. The method comprises the steps of receiving end user requests to create respective new groups, each request identifying one or more parameter fields for describing items or services belonging to the group and one or more locations within the existing group hierarchy, and modifying the existing hierarchy to accommodate the new groups.

The method may comprise submitting said end user requests via graphical user interfaces displayed on end user terminals, and delivering the requests via the Internet to a web server or servers on which said trading system is hosted. More particularly, the graphical user interface may be configured to enable an end user to select the location(s) of a new group within the hierarchy.

One embodiment of the invention requires that each said end user request includes a name of the group and a textual description of the group. The request may also include a set of values associated with a parameter field, the values forming a user selectable list.

The method may comprise the further steps of receiving an end user request to modify an existing group and modifying that existing group. More particularly, the request may include:
a) an indication of parameter fields to be deleted or added;
b) an indication of text to be amended, deleted or added; or
c) an indication of a new location for the group within the hierarchy.

The group hierarchy may be stored in a memory of the on-line trading system as one or more directed graphs.

The request may identify a parameter field by way of a selection of parameter field associated with a pre-existing group.

The request may identify a parameter field by way of a selection of a standard parameter field defined by the on-line trading system.

The or at least one of the parameter fields associated with a request may be multi-dimensional, e.g. allowing an item characteristic to be specified using two or more sub-fields.

According to a second aspect of the present invention there is provided an on-line trading system employing a group hierarchy constructed using the method of the above first aspect, the system maintaining a catalogue of items and/or services for trading, each item and/or service being directly associated with one of said groups.

The on-line trading system may be configured to store, in association with each group, a group name, as well as, for each group with which an item or service is associated, at least one parameter field for defining a property of an item or service associated with the group. The system may be further configured to present to an end user terminal, for a given group, a graphical user interface containing a text entry field for each parameter field of the group, to receive the input text, and to store the input text as an alternative user selectable language. The system may be still further configured to present to an end user terminal, for a given group, a graphical user interface allowing a user to select a language from a set of languages in which text associated with group parameter fields is displayed.

The on-line trading system may be configured to present to an end user terminal, for a given group, a graphical user interface allowing a user to search for items and/or services in the catalogue by selecting values for one or more parameter fields of the group.

The invention is applicable in particular, though not necessarily, to a system for providing a barter service for end users, automatically searching said catalogue to match users' Have's and Want's and delivering results to end users.

The system may be further configured to present to an end user terminal, for a given group, a graphical user interface allowing a user to add, delete and/or amend values associated with a parameter field of that group.

According to a third aspect of the present invention there is provided an online trading system comprising a web server or web server cluster configured to host an on-line trading system accessible by a multiplicity of end users possessing respective user terminals connected to the Internet, the web server or web server cluster comprising:
a first memory storing a group hierarchy, where nodes of the hierarchy define respective item and/or service groups with progressively increasing levels of detail, and storing for at least each group at the bottom of the hierarchy at least one user parameter field for describing items or services associated with the group;
a second memory for storing details of items and/or services offered for trade on the system including for each item and/or service the identity of at least one group with which that item or service is associated and a user selection for the or each parameter field; and
a processor for receiving end user requests to create new groups, each request including one or more user parameter fields for describing items or services belonging to the group and one or more locations within the existing group hierarchy, and for accessing said first memory to modify the existing hierarchy to accommodate the new groups.

According to a fourth aspect of the present invention there is provided an online trading system comprising a web server or web server cluster configured to host an on-line trading system accessible by a multiplicity of end users connected to the Internet, the on-line trading system being arranged to:
maintain a hierarchical structure of groups, each group possessing a name and at least those groups at the bottom of the hierarchy each possessing one or more parameter fields defining respective properties of items or services associated with the group;
maintain a catalogue of user items and/or services for trade, each item or service being associated with at least one group for the purpose of categorising the item or service and being defined by a user selection for the or each parameter field of the group;
receive new group definitions from end users including at least one parameter field and add corresponding new groups to the hierarchical structure; and
receive details of new items or services to be added to the catalogue including associations with the new groups and a user selection for the or each parameter field of the groups.

### BRIEF DESCRIPTION OF THE DRAWINGS

FIG. 1 illustrates schematically a Group or category of an online barter system, including properties of the Group;

FIGS. 2A to 2F illustrates various screens of a Graphical User Interface of an online barter system, suitable for User Creation of Group;

FIG. 2G illustrates a Screen of the Graphical User Interface of an online barter system that allows a Group Creator to import parameters from an existing Group into a new Group being established by the Creator;

FIGS. 3A and 3B illustrate a Group hierarchy before and after addition of new Groups to the hierarchy;

FIG. 4 shows a screen of a Graphical User interface illustrating a portion of a Group hierarchy;

FIG. 5 shows a screen of a Graphical User interface allowing a Group Creator to link a new Group into the existing Group hierarchy;

FIG. 6 shows in detail a screen of a Graphical User Interface for allowing a User to create a new Group;

FIG. 7 is a flow diagram illustrating a process for creating a new Group;

FIG. 8 is a flow diagram illustrating a search procedure for an online trading system; and

FIG. 9 is a flow diagram illustrating a generic search procedure for an online trading system.

### DESCRIPTION

It is proposed here to provide an on-line trading system that allows users, by way of a specially designed graphical user interface (GUI), to create, modify, and potentially delete categories used to categorise product and/or service. The system is essentially a web 2.0 based system in that it places implicit trust in the users to act collaboratively and responsibly when handling categories but, at the same time, is self-policing in that mistakes and deliberate errors by the inconsiderate few can be corrected by the responsible majority. As groups of end users will almost always be more knowledgeable than the system operator (consider for example stamp collectors, mountain bikers, or bull dozer enthusiasts), this approach will allow a growing number of product groups to be created that will describe actual items and services in a realistic and truly meaningful way.

Furthermore, this approach will allow users to translate existing categories into another language. A clear benefit is that the structure of the existing category, i.e. its place in the category tree, parameter fields, value, etc, can be retained, with only the text needing to be translated. The category remains as a single category, with different language options.

In the detailed description of an on-line barter system presented below, the following terms are used:

User: System user (person or some other entity, possibly automated) with a specified profile and privileges who trades with the barter system. In some cases a User can also be a guest User without a predefined profile.
Group: A set of similar Items that have been described using the Item Parameter Fields belonging to that Group. Groups are linking together in a hierarchy (e.g. in a tree structure). The same group may be linked into several different places in the hierarchy.
Creator: A User who creates and/or translates Groups.
System: A computer system in which the service software is run.
Moderator: A User who has privileges to moderate and administrate certain Groups or Forums.
Item: Item for trading. An item can be a product, service, right, obligation, share certificate, currency, immaterial item; in fact anything that can be traded. Each item belongs to a specific Group (or possibly many specific Groups) in the barter system and has been specified using the Item Parameter Fields of the specific Group(s).
Standard Parameter Field: The system has a set of standard or “library” Parameter Fields that can be applied to many different Groups as Item Parameter Fields. Values belonging to Standard Parameter Fields can be for example; colour, age group (e.g. babies 0-1 year old, children 1-2, etc.), title, open text description, image of the Item, etc.
Specific Parameter Field: Specific Parameter Fields are parameter fields that are specific to a specific Group or Groups. For example, parameter fields for a mountain bike Group may include a description of the fork and shock hardware.
Item Parameter Fields: Metadata for a specific group that is in practice a set of Parameter Fields (Standard Parameter Fields or Specific Parameter Fields) that are used to define and describe all Items that belong to a specific Group. Item Parameter Fields may include both standard and specific parameter fields. An Item Parameter Field allows a user to for example select a value from a predefined list of values, e.g. colours, weights, sizes, or may allow a user to select a value using a free-form entry.
Hierarchy: The organization of all Groups in the system defining the relations between the Groups. The Hierarchy is a tree or in a more general format a directed graph (either a connected or unconnected graph).
Forum: A group of User's having an interest, activity, or purpose in common (e.g. hobby, work place, university, location, etc). Users join a Forum when registering or logging-on to the system.
Value Category: A defined value or value range of an Item. This is important as trades are often based upon matching Items of similar value. In some cases, trades between different value categories can also be allowed. A Value Category could be for example $100-$199.
Inheritance: A group may inherit its Item Parameter Fields from another group. In practice this means that the Item Parameter Fields of the parent group are added to the Item Parameter Fields of a child group (which then may be augmented by adding further Item Parameter Fields).
Parameter Field Creation Tool: A tool that allows a User to define new Parameter Fields for the Item Parameter Fields of a particular group.
Want: Item that a User wants to acquire and is willing to give something in exchange for.
Have: Item that a User has and would like to give away in order to get something else in exchange.

Considering further the Item Parameter Fields, these can be complex, e.g. multi-dimensional. For example, a Parameter Field for weight may have two sub-fields, one for a value, e.g. 10, and one for a dimension, e.g. kg. As a further example, a Parameter Field may comprise nested sub-fields (including sub-fields nested within sub-fields) to allow a graded definition of a characteristic of an Item.

A top-level description of a procedure for defining a new group is as follows:
1. Define the Group description which includes the Group name and possibly a generic description about the Items that the Group includes.
2. Specify the Item Parameter Fields for a Group
   a. Select Item Parameter Fields for the Group from the list of Standard Parameter Fields
   b. Copy Specific Parameter Fields from another Group
   c. Create new Specific Parameter Fields for the Group using a Parameter Field Creation Tool
3. Link the new Group into the existing Group Hierarchy.

Above steps can be done in any appropriate order. The end result is the complete set of Item Parameter Fields for the Group.

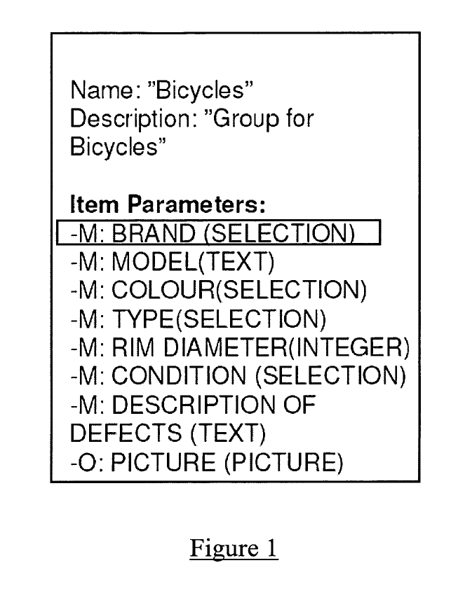

FIG. 1 illustrates the structure of a Group named “Bicycles”. As well as this name, the Group definition includes a textual description of the group, and a set of Item Parameter Fields. When creating the group, the Creator specifies whether Item Parameter Fields are mandatory (M) or optional (O). Certain of the items are Standard Parameter Fields, e.g. “Brand”, “Model”, whilst others are Specific Parameter Fields, e.g. “Rim Diameter”. Within an Item Parameter Field, the Creator can define a drop down menu with pre-set options. So, for the Item Parameter Field “Colour”, the drop down menu may offer various standard colours, red, blue, etc. Of course, these menus themselves may be hierarchical, offering further sub-choices.

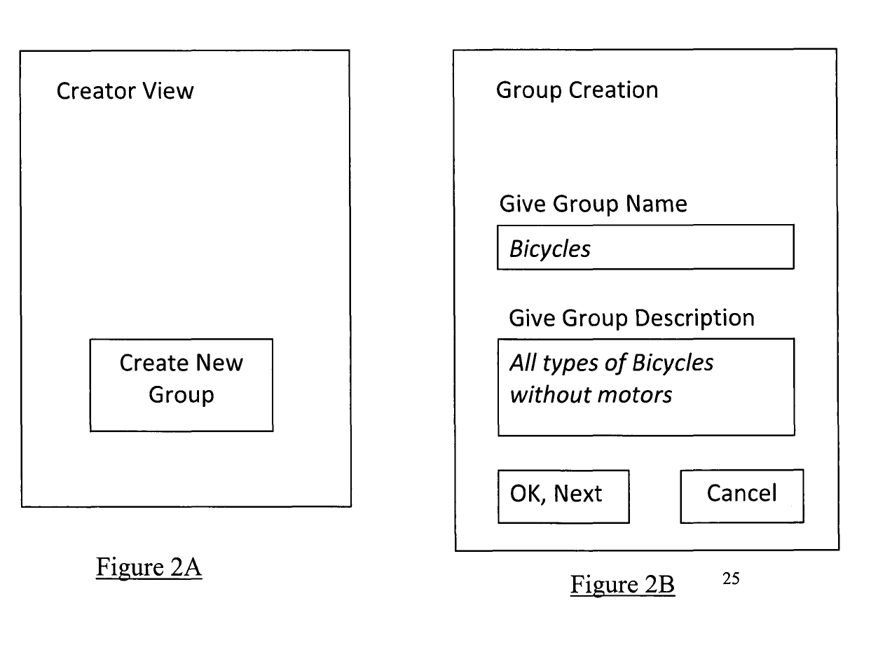

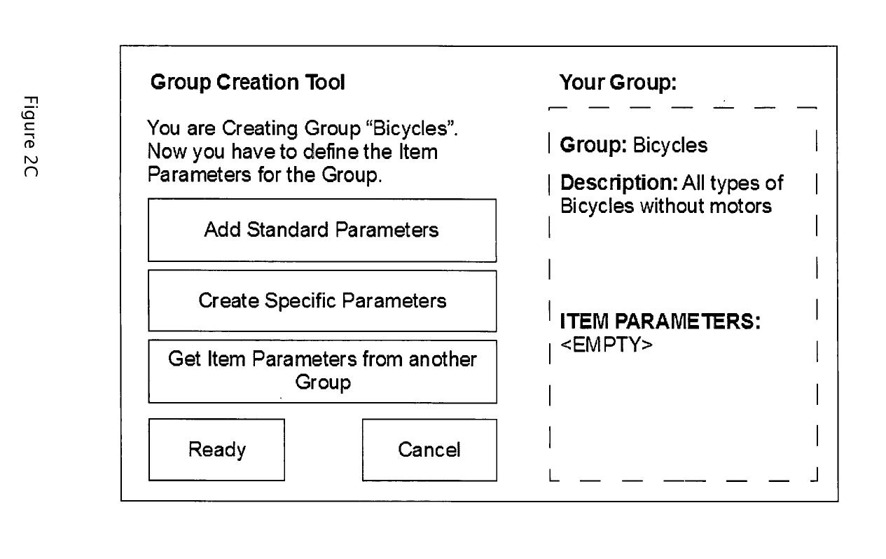

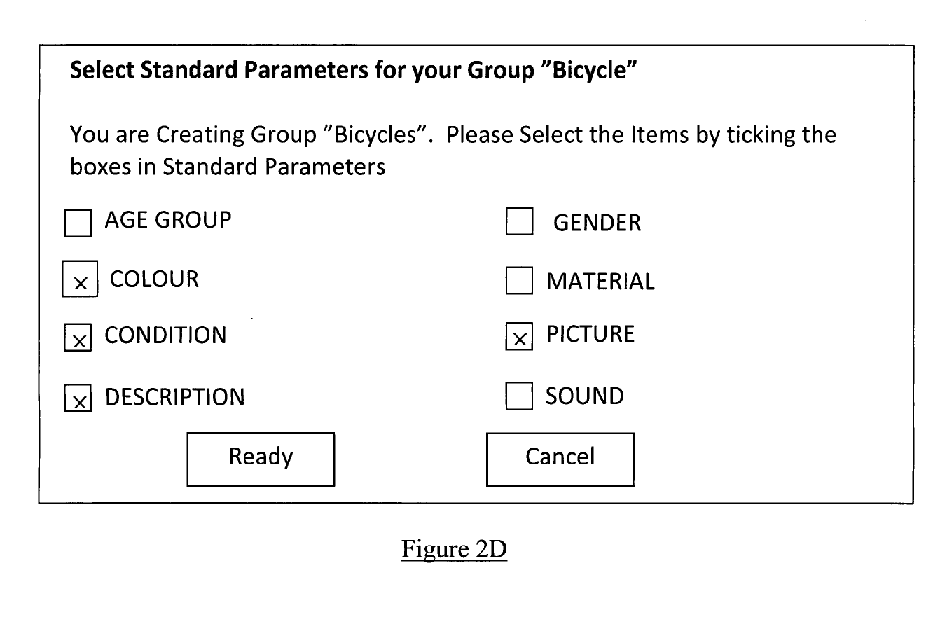

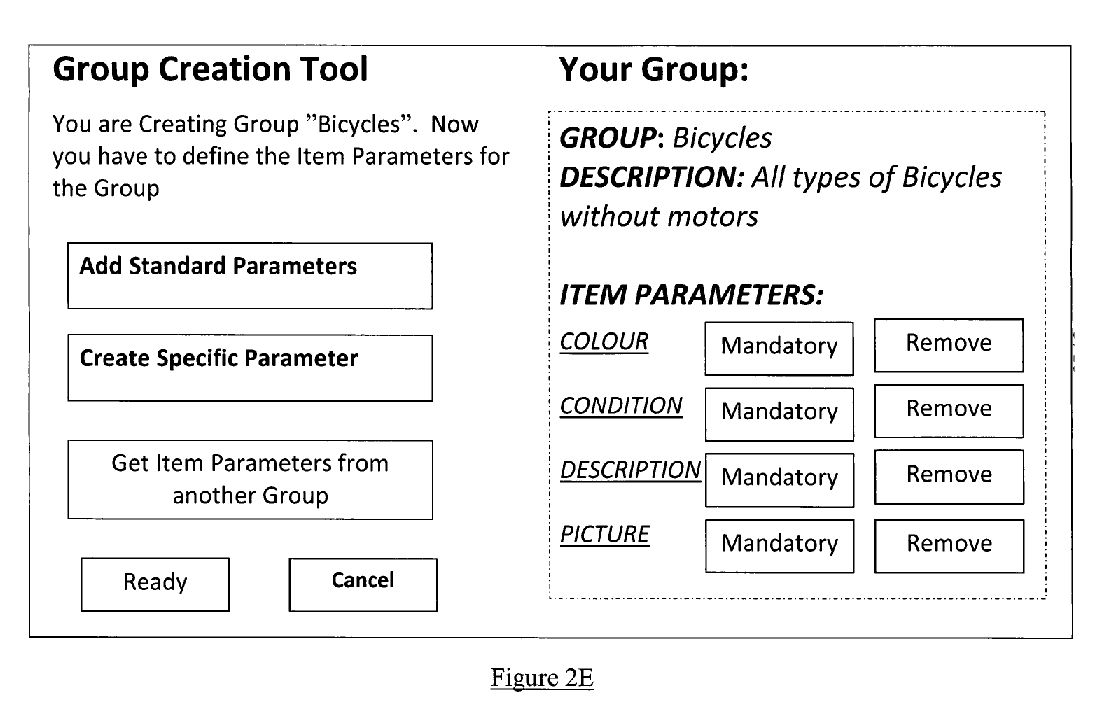

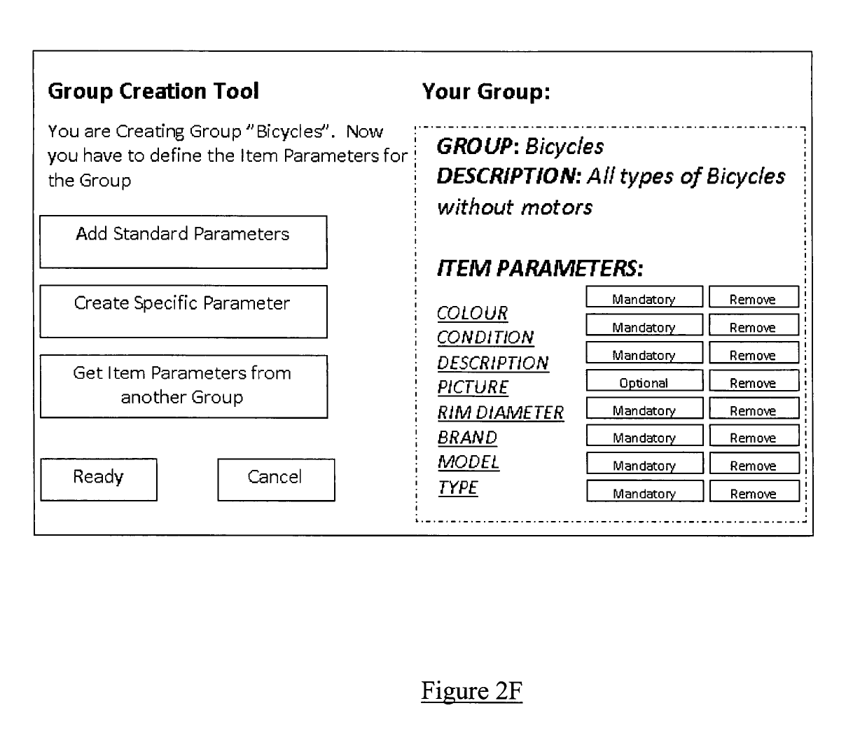

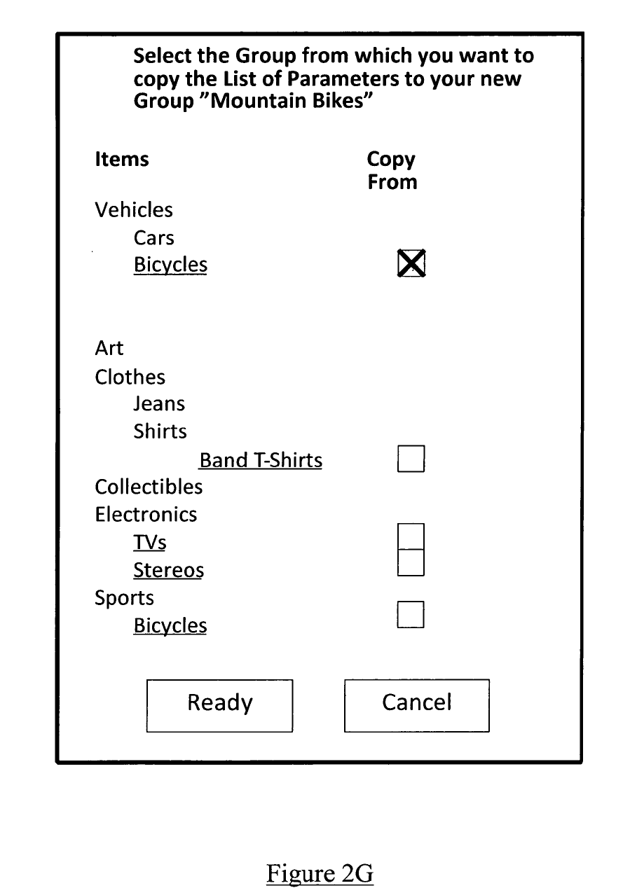

FIGS. 2A to 2F illustrates simplified graphical user interface screens for creating a group such as the Bicycle group of FIG. 1. Once a User has logged-on to the barter service, which may require pre-registration, he chooses to create a new group by selecting the appropriate option (FIG. 2A): the User clicks on the “Create New Group” button. This takes the User, who is now the Group Creator, to the screen view of FIG. 2B. The Creator enters the Group name and description into appropriate fields, and clicks on the “OK, Next” button, taking him to the screen of FIG. 2C. This screen allows the Creator to add Item Parameter Fields to the Group, either by using Standard Parameter Fields (using the screen of FIG. 2D), creating Specific Parameter Fields (using the screen of FIG. 2E), or by importing Parameter Fields from some other already defined Group (see below and FIG. 2G). FIG. 2F shows the GUI screen after the Creator has added a number of further Item Parameter Fields to the Bicycle Group.

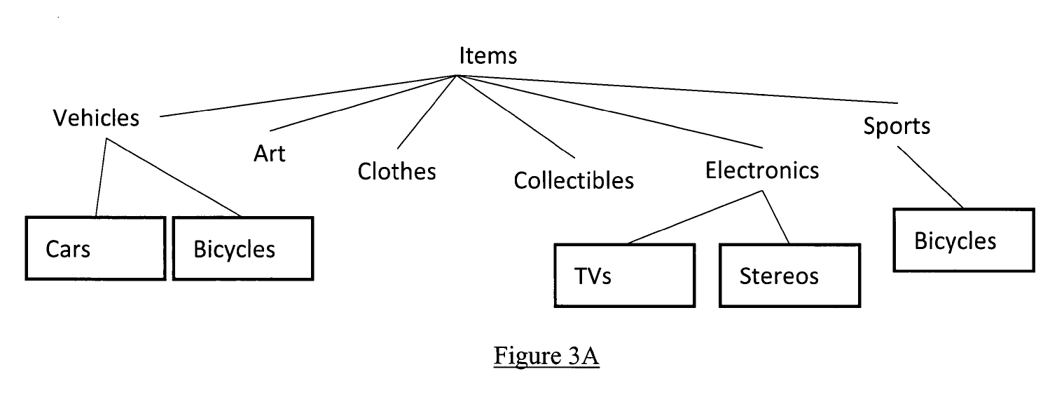

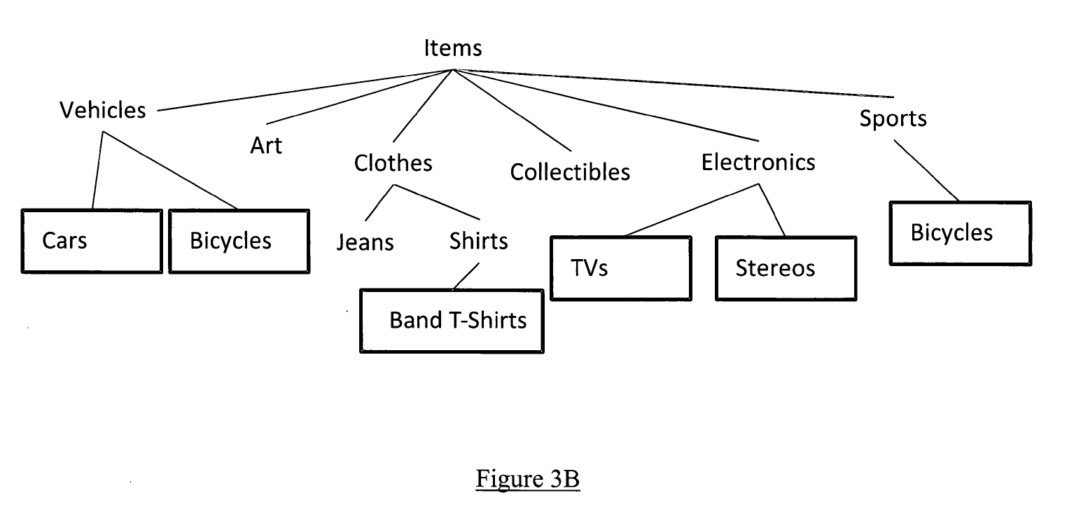

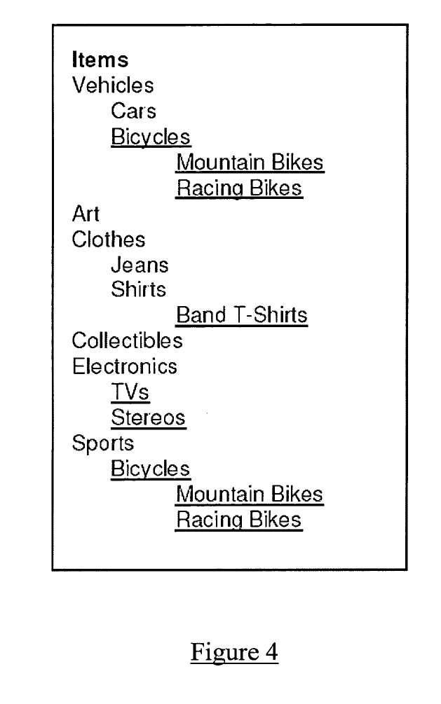

Once a Group has been created, it is necessary to connect the new Group to existing Groups within the Group Hierarchy. FIG. 3A illustrates by way of example a simple tree-like hierarchy for items. Primary categories include Vehicles, Art, Clothes, Collectibles, Electronics and Sports. Underneath the Vehicle Group are the Cars and Bicycle Groups. The Bicycle Group is also located under the Sports Group. TVs and Stereos are Groups located under the Electronics Group. Other groups may of course be defined. Items entered into the system may be directly associated only with Groups at the bottom of the tree, although this need not be the case and an item could be associated only with a top level or intermediate Group, e.g. Bicycles. FIG. 3B illustrates the Group hierarchy after Creators have created a number of new Groups and connected them into the hierarchy. FIG. 4 illustrates how a hierarchical view may be displayed to a User on the GUI of the system. Groups that are underlined are Groups that contain items on offer.

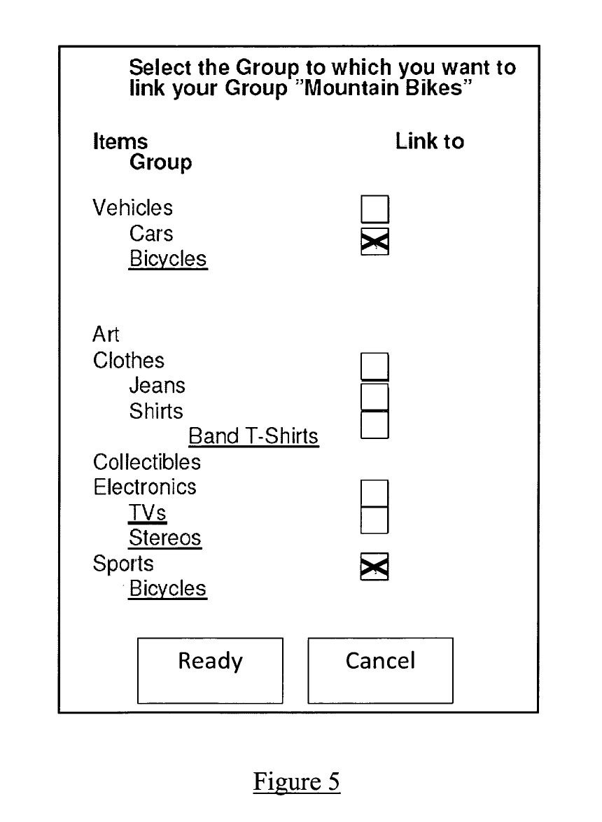

FIG. 5 illustrates a screen of the GUI that may be used by a Group Creator to connect an established Group into the Group hierarchy. The displayed screen shows that the Bicycles Group exists under both the Vehicles and Sports Groups. The Creator of a Mountain Bikes Group chooses to add this Group underneath both of the existing Bicycles Groups. It is noted that the system operator may not allow new Groups to be added directly under the top-level Groups, e.g. Vehicles, Art, etc. These top-level Groups are therefore statically defined by the operator. Of course, permissions to connect new Groups may be allocated in a dynamic fashion, e.g. a Creator of a new Group may have permission to allow and disallow the connection of further new Groups beneath his Group.

A new Group may be connected to a specific Forum in which case the Group may only be visible and/or accessible to members of that Forum. This may be important when trading confidential Items. As such, different Users will see different Group Hierarchies, depending upon the Forums of which they members.

FIG. 2G illustrates a GUI screen that may be displayed to a Creator in the process of establishing a Mountain Bikes Group. As part of the Parameter Field selection process, the Creator chooses to import parameter fields from the existing Bicycle Group.

The Group structure and Hierarchy is language independent. A mechanism may be provided for a) specifying the language of creation of a new Group and b) for translating text of an existing Group into another language. The GUI allows a User to select a language from a language menu and, optionally, to add a new language. The User is then presented for example with a screen which shows on one side the various text fields of the existing group (Group Name, Group Description, Item Parameter Field Names and all the Parameter Field Descriptions), and corresponding but blank fields for the translation. The User completes the blank fields and submits the translation. The User might then have the option to translate text for groups higher up and/or lower down in the same branch of the tree. A User browsing the hierarchy (e.g. to enter a Have or a Want into the system) may select a particular language.

Examples of other Groups and their Item Parameter Fields are:
Group name: Cell phones

### Item Parameter Fields:

Brand of the cell phone (drop down menu);
Model of the cell phone (drop down or free text);
Condition of the cell phone (drop down menu);
Age of the cell phone (drop down including “not known”);
Included items, for example phone, charger, user's manual (check mark list);

Picture of the cell phone from different angles (two pictures required: top and back of the phone).

Group name: Time share trading

### Item Parameter Fields:

Country of the apartment (drop down);
City of the apartment (search or drop down);
Address of the apartment (open text);
Size of the apartment (number (of sq.m.));
Number of rooms in apartment (number);
Number of persons apartment is suitable for (number);

Start date (date);

Length of stay offered (number of days).

An approval process may be implemented whereby new Groups and changes to existing Groups are submitted for approval. The submissions are reviewed and approved by another person (who could be another User, another creator User, a system administrator, or a specific service provider). After the approval the new Group, Item Parameter Fields, translation etc is published and brought into use. The approver may of course disapprove of a submission in which case the result is not brought into use. The approver may also give comments based on which the Creator can update the submission whereupon the approval process is repeated.

It is quite likely, indeed expected, that the product category tree will grow such that multiple Groups with very similar properties will exist in parallel. There will thus be a facility to merge Groups. The merge may be done by the system administrator, User, or one of the Group Creators. Permission to implement a Group merge may require a permission granted by the service administrator.

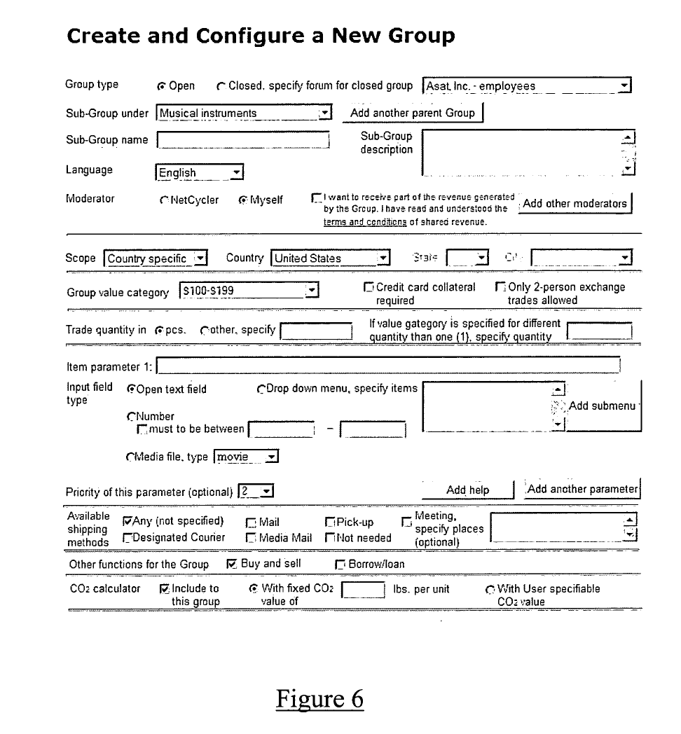

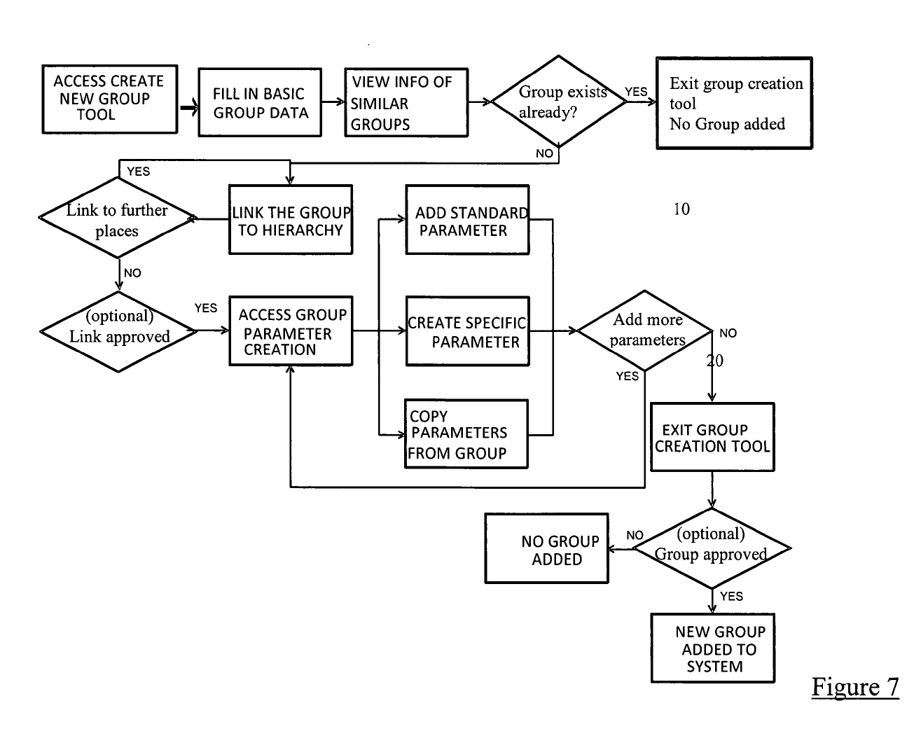

FIG. 6 illustrates an alternative GUI screen that is presented to a User after clicking on a Create New Group link. This screen integrates much of the functionality of the screen set of FIGS. 2A to 2G. The “Add another parent” button may be used repeatedly to enter the new Group into the existing Group Hierarchy. A language selection drop-down menu is provided. The lower entry section allows multiple Item Parameter Fields to be added to the Group.

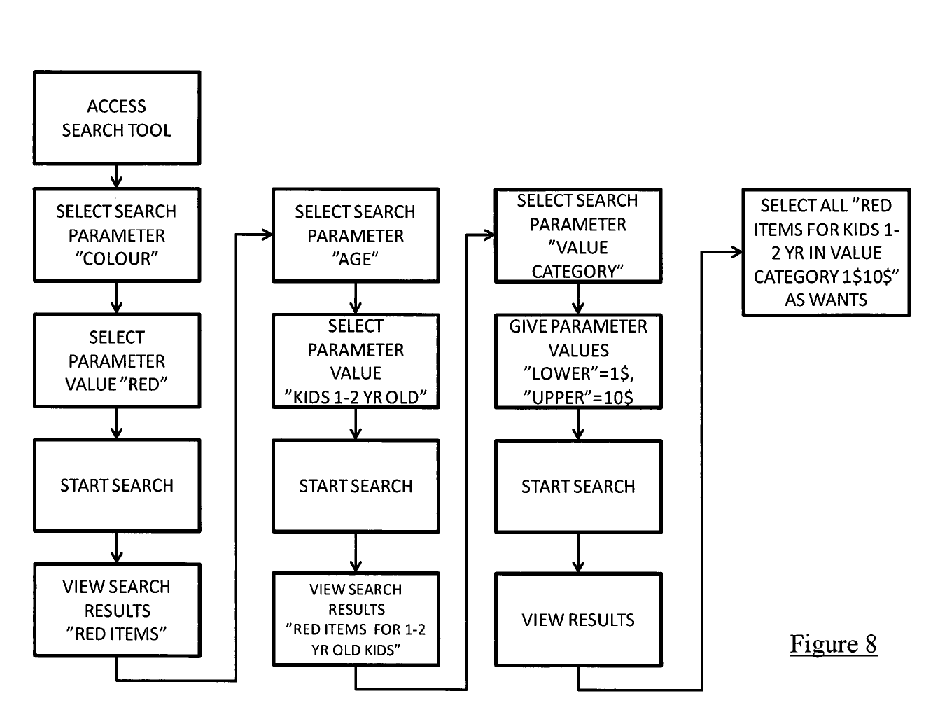

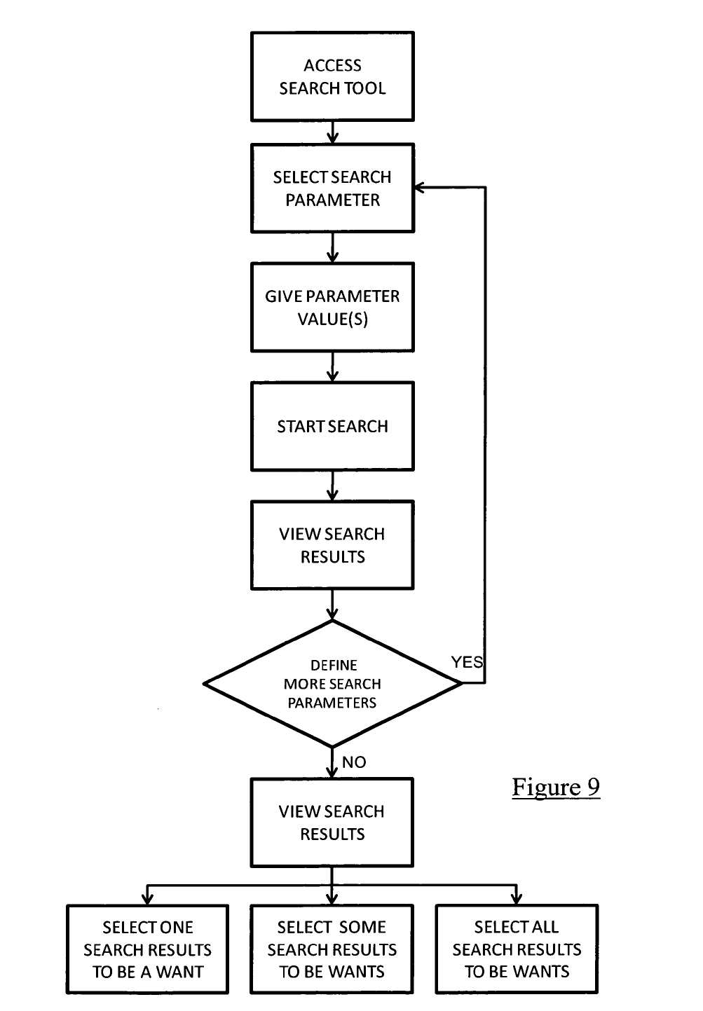

FIG. 7 is a flow diagram illustrating a procedure for creating a Group. FIG. 8 is a flow diagram illustrating a detailed procedure for searching for items or services catalogued using the Group Hierarchy structure. In this example, a user selects a first Item Parameter Field and enters a value, in this case “red” and views the results. Note that at this stage the system is searching across all groups. The user then refines the search in a stepwise manner by entering values into other Item Parameter Fields. FIG. 9 is a flow diagram illustrating the search procedure at a more abstracted level.

An Item Parameter Field established for a Group will often comprise a set of User selectable entries, e.g. displayed as a drop-down menu on a search page of the GUI. Where a User wishing to add an item or service to a Group (either as a Have or a Want) finds no relevant entry in such a set, the User may add such an entry. Consider for example a User wishing to add a concert ticket to a concert ticket group. If the relevant concert is not contained in an existing set, the User enters the new concert as a new entry for the Parameter Fields. Of course, some “smart” functionality may be introduced into the system to allow it to recognise a new entry that is similar to an existing entry, i.e. to avoid the creation of duplicates in the set. For Groups such as concert tickets, it may also be useful to add a further Parameter Field indicating an expiry date for an item, e.g. the date of a particular concert.

It will be clear that allowing Users to create and modify Groups will result in a catalogue of items and services that classifies the items and services with a much greater degree of accuracy (than conventional trading systems) using “standard” definitions, reducing reliance upon free text descriptions. This in turn greatly increases the accuracy with which automatic searches of a catalogue can be performed.

The on-line barter system described above will typically be hosted on a secure web server or web server cluster operated by the service provider. However, implementation over a peer-to-peer type network might also be possible. Users access the service via the Internet using person computers, laptops, PDAs, mobile phones and the like. In some cases, a special application may reside in the client terminal in order to allow the service to be accessed.

It will be appreciated by the person of skill in the art that various modifications may be made to the above described embodiments without departing from the scope of the present invention. For example, where an Item Parameter Field represents a standard unit of measure, e.g. weight, length, value, etc, conversion of that Parameter Field between different standards may be easily incorporated into the on-line system, e.g. to allow a User to switch easily between imperial and metric standards. A default standard may be presented to a user based upon a recorded profile of the user. Similarly, the profile may define a default language. The barter system described may be arranged in some cases to bind Users to enter into trades that are automatically identified by the system. More likely however, users may browse identified trades and thereafter confirm that a trade should take place.

System Internal Group descriptions may be based on a specific file format, e.g. XML (eXtensible Mark-up Language) or RDF (Resource Description Format). The system may provide an interface that can be used for uploading Group definitions using that file format. In the same way there may be an interface that allows Users to download Group descriptions from the System in the file format. This would allow the use of more elaborate Group creation tools for use by more professional Users.

1. A method of constructing and maintaining a group hierarchy for use in an online trading system accessible to a multiplicity of end users, where nodes of the hierarchy define respective item and/or service groups with progressively increasing levels of detail, items and/or services offered for trade on the system being directly associated with at least one group, the method comprising:
at a web server or web server cluster, receiving end user requests to create respective new groups, each request identifying one or more parameter fields for describing items or services belonging to the group and one or more locations within the existing group hierarchy; and
using the web server or web server cluster to modify the existing hierarchy to accommodate the new groups.

2. A method according to claim 1 and comprising submitting said end user requests via graphical user interfaces displayed on end user terminals, and delivering the requests via the Internet to the web server or web server cluster on which said trading system is hosted.

3. A method according to claim 2, the graphical user interface enabling an end user to select the location(s) of a new group within the hierarchy.

4. A method according to claim 1, each said end user request including at least a name of the group.

5. A method according claim 1, each said end user request including at least a textual description of the group.

6. A method according to claim 5, wherein an end user request includes a set of values associated with a parameter field, the values forming a user selectable list.

7. A method according to claim 1 and comprising:
receiving an end user request to modify an existing group; and
modifying that existing group.

8. A method according to claim 7, wherein said request includes:
a) an indication of parameter fields to be deleted or added;
b) an indication of text to be amended, deleted or added; or
c) an indication of a new location for the group within the hierarchy.

9. A method according to claim 1, wherein said group hierarchy is stored in a memory of the on-line trading system as one or more directed graphs.

10. A method according to claim 1, said request identifying a parameter field by way of a selection of a parameter field associated with a pre-existing group.

11. A method according to claim 1, said request identifying a parameter field by way of a selection of a standard parameter field defined by the on-line trading system.

12. A method according to claim 1, the or at least one of the parameter fields being multi-dimensional and/or comprising nested sub-fields.

13. An on-line trading system employing a group hierarchy constructed using the method of claim 1, the system maintaining a catalogue of items and/or services for trading, each item and/or service being directly associated with one of said groups.

14. An on-line trading system according to claim 13 and being configured to store, in association with each group, a group name.

15. An on-line trading system according to claim 14 and being configured to store, for each group with which an item or service is associated, at least one parameter field for defining a property of an item or service associated with the group.

16. An on-line trading system according to claim 15 and being configured to present to an end user terminal, for a given group, a graphical user interface containing a text entry field for each parameter field of the group, to receive the input text, and to store the input text as an alternative user selectable language.

17. An on-line trading system according to claim 16 and being configured to present to an end user terminal, for a given group, a graphical user interface allowing a user to select a language from a set of languages in which text associated with group parameter fields is displayed.

18. An on-line trading system according to claim 13 and being configured to present to an end user terminal, for a given group, a graphical user interface allowing a user to search for items and/or services in the catalogue by selecting values for one or more parameter fields of the group.

19. An on-line trading system according to claim 13, the system providing a barter service for end users, automatically searching said catalogue to match users' Have's and Want's and delivering results to end users.

20. An on-line trading system according to claim 13 and being configured to present to an end user terminal, for a given group, a graphical user interface allowing a user to add, delete and/or amend values associated with a parameter field of that group.

21. An online trading system comprising a web server or web server cluster configured to host an on-line trading system accessible by a multiplicity of end users possessing respective user terminals connected to the Internet, the web server or web server cluster comprising:
a first memory storing a group hierarchy, where nodes of the hierarchy define respective item and/or service groups with progressively increasing levels of detail, and storing for at least each group at the bottom of the hierarchy at least one user parameter field for describing items or services associated with the group;
a second memory for storing details of items and/or services offered for trade on the system including for each item and/or service the identity of at least one group with which that item or service is associated and a user selection for the or each parameter field; and
a processor for receiving end user requests to create new groups, each request including one or more user parameter fields for describing items or services belonging to the group and one or more locations within the existing group hierarchy, and for accessing said first memory to modify the existing hierarchy to accommodate the new groups.

22. An online trading system comprising a web server or web server cluster configured to host an on-line trading system accessible by a multiplicity of end users connected to the Internet, the on-line trading system being arranged to:
maintain a hierarchical structure of groups, each group possessing a name and at least those groups at the bottom of the hierarchy each possessing one or more parameter fields defining respective properties of items or services associated with the group;
maintain a catalogue of user items and/or services for trade, each item or service being associated with at least one group for the purpose of categorising the item or service and being defined by a user selection for the or each parameter field of the group;
receive new group definitions from end users including at least one parameter field and add corresponding new groups to the hierarchical structure; and
receive details of new items or services to be added to the catalogue including associations with the new groups and a user selection for the or each parameter field of the groups.
